(19) United States
(12) Patent Application Publication
(10) Pub. No.: US 2002/0058179 A1
(43) Pub. Date: May 16, 2002

(54) Electrical conducting, non-woven textile fabric

(76) Inventors: Paul N. Segit, Exeter, NH (US); David R. Lambert, Somersworth, NH (US)

Correspondence Address: BIRCH STEWART KOLASCH & BIRCH, PO BOX 747, FALLS CHURCH, VA, 22040-0747, US

(21) Appl. No.: 09/948,791

(22) Filed: Sep. 10, 2001

Related U.S. Application Data
(60) Provisional application No. 60/231,951, filed on Sep. 12, 2000.

(51) Int. Cl. H01M 4/66; H01M 4/88; B32B 27/12

(52) U.S. Cl. 429/44; 429/245; 427/115; 502/101; 428/297.4

(57) ABSTRACT

The present invention provides a flexible pyrolyzed carbon fiber matrix, suitable for use as a fuel cell electrode substrate. The product is characterized by controlled microporosity and is at least partially hydrophobic. The product is made by a continuous, high speed, high volume manufacturing process, which permits wide variability in such parameters as basis weight (50-150 gm/m²), caliper (140-400 m² at 5 Kpa), density (0.300-0.480 gm/cm³), and resistivity (200-1000 mOhm-cm through plane and 15-65 mOhm-cm in plane). This matrix, unlike current electrode substrates, is flexible and can be made as roll goods. Comparative testing in fuel cell applications has demonstrated that this electrode substrate performs comparably to currently available electrode substrates. A fuel cell equipped with the present electrode substrate will produce a polarization curve which is virtually the same as that produced by a fuel cell equipped with a conventional electrode substrate.

The present invention relates to an at least partially hydrophobic, porous, electrical conducting, non-woven textile fabric, and to processes for producing such textile fabric. The invention especially relates to such fabric for use in electrochemical apparatus, e.g. fuel cells.

### BACKGROUND OF THE INVENTION

Electrical conducting textile fabrics are used in a wide variety of applications, among which are electrode substrates in electrochemical processes, conductive filters in high-efficiency filtration applications, statically charged filters, protecting devices for unwanted electromagnetic waves, and the like. All of such applications have the common requirement that the textile fabrics have high electrical conductivity. Since textile fabrics are normally made of non-conducting fibers, e.g. cotton, synthetic, e.g. polymer, and wool fibers, it is necessary that such fabrics be substantially modified in regard to one or more of the fibers, the makeup of the fabric, and the process for making the fabrics. These modifications are slightly different for the particular electrically conductive fabric application. For purposes of conciseness, the description of the invention herein will be illustrated by only one of those applications, although the invention is fully applicable to the breadth of the applications noted above.

A very important application of an electrical conducting textile fabric is that of an electrode substrate for a fuel cell. That application will be used hereinafter, as noted above. Very basically, a fuel cell combines hydrogen and oxygen, usually from air but pure oxygen may be used, to produce electricity and water. Conducting electrodes are serially separated in the fuel cell and are contacted by a common electrolyte for the fuel cell, for example, a polymer electrolyte membrane or proton exchange membrane. In general, electrical conductive textile fabrics may be made of metal fibers or electrical conducting polymer fibers, or carbon fibers, and all those fibers are fully satisfactory for the present invention when used for other than fuel cells. The usual fibers for fuel cell electrode substrates are carbon fibers. Accordingly, since the example being illustrated for conciseness is in connection with electrode substrates for fuel cells, only the present pyrolyzed carbon fibers will be discussed in any detail hereinafter.

Pyrolyzed carbon fibers are generally considered to have at least 90% carbon therein, and typically have a diameter between 5 to 10 microns, although diameters between about 1 and 30 microns may be used. Pyrolyzed carbon fibers can be produced from a variety of carbon-containing starting materials such as pitch, rayon, and cotton, but more usually, the fibers are now produced from polyacrylonitrile (PAN). The general procedure for producing the fibers is that of pyrolyzing the starting material at temperatures in excess of 1,000° C., e.g., 1200-1400° C., and up to over 3000° C., in a non-oxidizing atmosphere. When the starting material fibers are pyrolyzed at such temperatures, the electrical conductivity increases by ten orders of magnitude or greater, depending on the pyrolysis temperature. Generally, the higher the pyrolysis temperature, the greater the electrical conductivity of the fibers. On the other hand, the greater the pyrolysis temperature, the more fragile the resulting carbon fibers. Indeed, at higher pyrolysis temperatures, carbon fibers become so fragile that they are difficult to handle for forming into the shape of an electrode substrate. Nonetheless, because of the high conductivity of the pyrolyzed carbon, pyrolyzed carbon fibers are ideal for producing fuel cell electrode substrates and most of the fuel cell electrode substrates are composed of such carbon fibers.

One way of somewhat mitigating the fragility of the carbon fibers is to first weave a textile fabric of the starting material fibers, e.g., polyacrylonitrile (PAN), form the woven textile into a shape generally required for a fuel cell electrode substrate, and then pyrolyze that formed shape to produce the pyrolyzed carbon fibers in that woven textile. This provides more of a consolidated matrix of the carbon fibers for handling and shaping the pyrolyzed woven textile into an electrode substrate for a fuel cell. However, even with this approach, it is very difficult to handle and shape such pyrolyzed textiles into an electrode substrate for a fuel cell. Another method is to form a non-woven textile of the starting fibers (PAN) and pyrolyze that non-woven textile in the same manner described above. This approach allows the non-woven textile to be fashioned in a more precise configuration required for a fuel cell electrode substrate. But, on the other hand, the non-woven pyrolyzed textile results in a more fragile matrix than that of the corresponding woven textile.

As noted above, electrical conductivity of the pyrolyzed carbon increases with the temperature of pyrolyzation. Therefore, it is desirable to pyrolyze at the higher temperatures in order to increase electrical conductivity, although the fragileness of the resulting matrix likewise increases. This has, therefore, formed something of a dilemma in the art. At lower pyrolysis temperatures, the conductivity of the resulting matrix is lower and results in less efficient fuel cells. On the other hand, at higher pyrolysis temperatures, while conductivity is greater, the matrix of the resulting carbon fibers is very fragile, very expensive to make, difficult to form into an electrode substrate, and difficult to assemble in a fuel cell. All of this results in a very expensive fuel cell.

In addition, for optimization of efficiency in certain fuel cells, it is desirable that the electrode substrates be at least partially hydrophobic. Water is a product of the reaction of the fuel cell, and hydrogen must penetrate one of the electrode substrates of a pair of electrode substrates and oxygen must penetrate the other. A reaction of the hydrogen and oxygen takes place to produce water. Water should be expelled from the electrode substrate as rapidly as possible so as to continually provide surface area for the reaction between the hydrogen and oxygen. By rendering the electrode substrate at least partially hydrophobic, water does not collect in the electrode substrate and is rapidly removed therefrom for greater overall efficiency of the fuel cell. It has, however, been very difficult to provide controlled hydrophobicity to fuel cell electrode substrates because of the very fragile nature of the carbon fibers making up the electrode substrates, as described above.

One method of controlling hydrophobicity is to precoat carbon fibers with hydrophobic materials. (See U.S. Pat. No. 5,865,968, identified below), but this approach decreases the electrical conductivity of the matrix and results in a non-uniform substrate. In addition, most hydrophobic materials, e.g., fluorinated materials and especially fluorinated polymers, are not electrically conductive. If those materials reach intersections between conducting carbon fibers and reside at those intersections, which will occur when carbon fibers are precoated with the hydrophobic polymer, the overall electrical conductivity of the fuel cell textile substrate is very substantially decreased. Thus, the efficiency of the fuel cell likewise decreases. Even further, precoated hydrophobic materials tend to blind pores in the electrical conducting textile substrate. Since the electrode substrates in a fuel cell must be substantially porous for diffusion of hydrogen and oxygen, substantial decreases in porosity results in substantial decreases in efficiency of the fuel cell. In the present invention the staple fibers are not significantly precoated and especially not precoated with hydrophobic materials, i.e., the present staple fibers are substantially uncoated.

By the term substantially uncoated is meant that carbon fibers used to make the present textile fabric have no coating thereon which is significant to the present fabric or process for making the fabric. The substantially uncoated carbon fibers may have insignificant coating, such as aids for processing the carbon fibers during manufacture thereof, and the like. Of course, as explained in detail below, the uncoated fibers, ultimately, have fibrils of a hydrophobic material attached thereto and mixed therewith to make the present textile fabric, but these fibrils are not in the form of a coating, as that term is normally used. A full discussion of the foregoing is set forth in detail in U.S. Pat. No. 5,865,968, issued on Feb. 2, 1999 to Denton et al., which patent is incorporated herein by reference.

Accordingly, it can be easily seen that a substantial advantage to the art would be provided by an electrical conducting textile fabric which can be used, among other things, as an electrode substrate for fuel cells and which does not suffer from the disadvantages of current textiles for use as fuel cell electrode substrates, as described above.

### BRIEF SUMMARY OF THE INVENTION

The present invention is based on several primary and subsidiary discoveries.

Firstly, as a primary discovery, it was found that electrical conducting substantially uncoated staple fibers, e.g., already pyrolyzed carbon fibers, could be laid into a matrix which could be, ultimately, formed into a self-supporting electrical conductive non-woven textile fabric.

As a second primary discovery, it was found that electrical conductive particulate filler could be disposed in the matrix of the substantially uncoated staple fibers and the electrical conducting particulate filler greatly increases the overall conductivity and surface area of the matrix, especially when a hydrophobic material is placed in the matrix. Since the fibers are substantially uncoated, and therefore remain electrically conductive, the filler dispersed among the fibers provides additional electrical pathways.

As a third primary discovery, it was found that an at least partially hydrophobic polymer, at least partially in the form of fibrils, may be disposed in the matrix and at least in part attached to and mixed with the uncoated fibers and filler. This provides the matrix with at least partially hydrophobic properties but, in combination with the filler as discussed in more detail below, allows for a retention of the high conductivity of the matrix.

As a primary discovery, it was found that when the matrix is a wet-laid matrix, then the fibers, the filler, and the hydrophobic polymer may be flocculated and laid at the same time so as to provide an intimate and uniform dispersion of all three of those components. After appropriate dewatering, drying and heating, as explained below, a very uniform at least partially hydrophobic and yet highly electrical conducting textile fabric is produced.

In this latter regard, and as a further primary discovery, it was found that when the staple fibers, the particulate filler and a dispersion of a hydrophobic polymer are in the form of an aqueous suspension, then that suspension can be flocculated in a very controlled manner so that the flocs deposited on a formaceous body, e.g., a screen, form a very uniform matrix. After drying and heating at appropriate temperatures a strong self-supporting textile fabric is provided.

As a subsidiary discovery, it was found that if the matrix reaches higher temperatures, especially between about 600° F. and 700° F. (315° C.-371° C.), then the resulting non-woven textile fabric has very substantial handling properties, is of controlled hydrophobicity and is of high conductivity.

Thus, very briefly stated, the present invention provides an at least partially hydrophobic, porous, electrical conducting, non-woven textile fabric. The fabric is composed of a flocculated and laid matrix of substantially uncoated electrical conducting staple fibers. Electrical conducting particulate filler is disposed in the matrix and an at least partially hydrophobic polymer, at least partially in the form of fibrils, is disposed in the matrix and is at least partially attached to and mixed with the fibers and the filler.

There is also provided a process for producing that textile fabric. The substantially uncoated staple fibers, particulate filler and a suspension of a hydrophobic polymer are dispersed in an aqueous medium to form a suspension thereof. That suspension is flocculated to form flocs (of the solids) and the flocs are deposited on a formaceous body to form a matrix. The matrix is dewatered on the formacous body and is subjected to heating at softening temperatures of the hydrophobic polymer. The matrix is pressed at the softening temperatures to form fibrils of the hydrophobic polymer so that the fibrils are at least partially attached to and mixed with the carbon fibers and filler to form a strong self-supporting textile fabric.

### BRIEF DESCRIPTION OF THE DRAWINGS

FIG. 1 is an idealized schematic rendition of a photomicrograph of the textile fabric of the present invention;

FIG. 2 is a schematic diagram of a typical process for producing the present textile fabric; and

FIG. 3 is a schematic illustration of the present textile fabric disposed in a fuel cell.

### DESCRIPTION OF THE PREFERRED EMBODIMENT

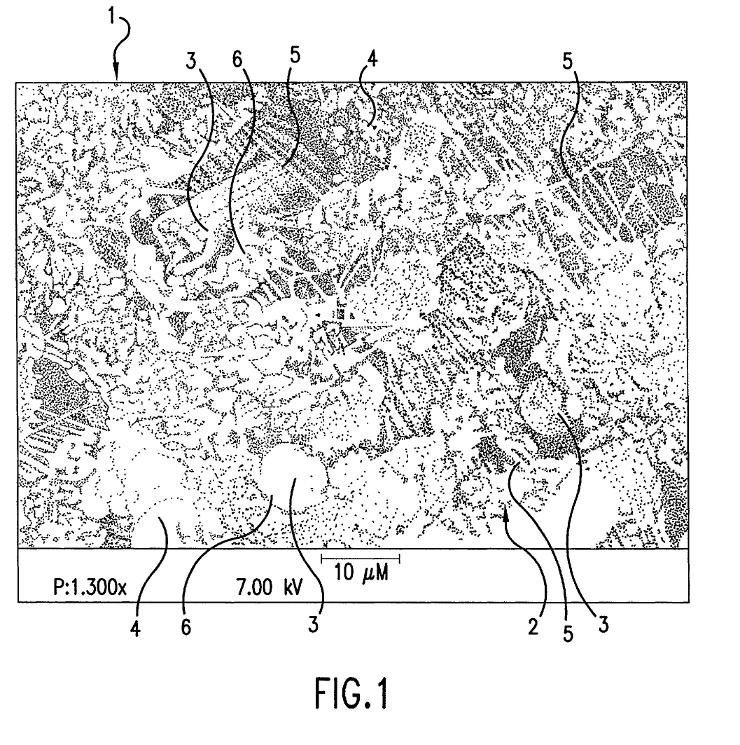

For an overall understanding of the present invention, reference is first made to FIG. 1, which is an idealized rendition of a photomicrograph of the present textile fabric. FIG. 1 shows components of the fabric for illustration purposes only and should not be considered to show specific physical arrangements. In FIG. 1, the textile fabric, generally 1, has a laid matrix, generally 2, of substantially uncoated electrical conducting fibers 3. When the fabric is to be used as fuel cell electrode substrates, the fibers are pyrolyzed carbon staple fibers. Disposed in the matrix 2 is electrically conducting particulate filler 4, and an at least partially hydrophobic polymer, at least partially in the form of fibrils 5, is disposed in the matrix 2 among the carbon fibers 3 and in contact with filler 4. While not being bound by theory, it is believed that the hydrophobic polymer, when softened during a heating step at the temperatures discussed below, is amenable to fibrilation when placed under mechanical pressure between nip rolls. Since the form of the hydrophobic polymer so produce is between about 0.1 and 5 microns, in thickness, that form is really not a fiber, in the conventional sense of the word, but is a fibril. The fibrils, however, can be quite long, e.g. have an average length of between about 10 and 1000 microns. These fibrils present a very great surface area in the matrix and, hence, produce substantial hydrophobicity with a relatively small weight percent of the matrix. Further, since these fibrils are disposed among the carbon fibers, they provide a strong and flexible matrix. Nevertheless, the non-conducting hydrophobic polymer fibrils do decrease the overall conductivity of the textile fabric on a weight basis. Thus, making the textile fabric at least partially hydrophobic for the advantages discussed above can result in significant decreases in overall conductivity of the textile fabric.

However, with the present invention, electrical conducting particulate filler 4 is also included in the matrix. That filler bridges between many of the electrical conducting staple fibers 3, especially at intersections 6, as well as other places, as shown in FIG. 1. Since the filler is electrically conductive, the filler creates additional paths of conductivity between the staple fibers beyond that provided at the intersections of those fibers. Thus, even if electrical conductivity is reduced by reason of the fibrils of the hydrophobic polymer, the conductive filler bridging conducting fibers 3 will compensate for that loss of conductivity. Actually, the overall conductivity of the textile fabric is increased.

While not necessary, a useful feature of the present invention is the use of fugative binders in the matrix. The fugative binder is used to render the matrix stronger during formation and processing thereof, but is removed from the matrix after the matrix is formed and is self-supporting. The binder is removed because most conventional binders are non-conductive, and the presence of the binder in the finished non-woven textile would only decrease the overall electrical conductivity of the non-woven textile on a weight basis. The binder is, preferable, partially water soluble, such as polyvinyl alcohol. The preferred manner of introducing the polyvinyl alcohol into the matrix is in the form of fibers. During the process of producing the matrix, as described in detail below, such water soluble fibers will at least partially dissolve in the aqueous medium from which the matrix is laid. Some of that dissolved polymer will result in material, in part somewhat film like, partially bridging staple fibers 3 and the filler 4. This greatly increase the flexibility of the matrix as it is being formed and dried. Most of the water soluble binder fibers will be dissolved during processing of the matrix and, hence, will be removed when the matrix is dewatered and washed. The remaining portions substantially contribute to the physical properties of the matrix through the drying steps. After drying, as explained below, the matrix is heated to 500° F. or greater. These temperatures burn away in remaining water soluble binder, either in the form of a film or fiber. Thus, in this sense, the binder is a fugative binder.

When using the water soluble binder fibers, it is important that the laid matrix 2 is a wet laid matrix. In this way, the staple fibers may be uniformly dispersed to form the matrix, the filler may be uniformly dispersed in the matrix to provide uniform electrical conductivity, and the water soluble binder fibers may uniformly provide support and flexibility.

The average length of the staple fibers 3 is between 1/16″ and ¾″ (0.16 cm and 1.9 cm). This is true whether or not the staple fibers are metal fibers, electrical conducting polymer fibers, carbon fibers, or mixtures thereof, when the textile fabric is intended for purposes other than as an electrode substrate for a fuel cell. Of course, in this latter case, as described above, the staple fibers are carbon fibers and, in that case, the average diameter of the fibers is between 1 and 50 microns.

While the carbon fibers may be made from any of the usual sources, as described above, it is preferred that the carbon fibers are derived from polyacrylonitrile and, consequently, the carbon fibers are pyrolyzed polyacrylonitrile fibers.

The filler can be any conductive particulate matter, including metal, electrical conducting polymer, and carbon or graphite. However, for purposes of a fuel cell, the particulate filler is preferably carbon or graphite and has an average particle diameter of between about 0.01 and 10 microns. The carbon filler may in the form of carbon micro fibers, milled carbon fibers, carbon black and acetylene carbon.

The hydrophobic polymer is preferably a fluorinated polymer and, more preferably, the fluorinated polymer is poly(tetrafluoroethylene). Depending on the intended use of the textile fabric, the weight amount of the hydrophobic polymer in the matrix can be between 1% and 30% of the weight of the matrix, but usually between about 1%-20% of the weight of the matrix. However, for use of the textile fabric in a fuel cell, the weight amount of the hydrophobic polymer in the matrix is between about 1% and 15% of the weight of the matrix and, more preferably, between about 3% and 10%. This range will provide substantially hydrophobicity to the textile fabric and, in addition, provide flexibility and strength to the finished textile fabric.

The binder fibers are, preferably, polyvinyl alcohol fibers and, more preferably, those polyvinyl alcohol fibers have average lengths of between about 1/16″ and ¾″ (0.16 cm and 1.9 cm). This will ensure that the binder fibers are distributed throughout the matrix and provide the support, as described above, for improved strength and flexibility of the forming matrix. While the polyvinyl alcohol fibers can vary considerably in diameter, it is preferable that the diameters of those fibers be between 1 and 40 microns.

Such textile fabrics have particularly good properties for fuel cell electrode substrates where the non-woven textile fabrics have a weight of from 50 to 150 grams per meter square, a caliper of 40 to 400 microns at 5 Kpa, a density of 0.36 to 0.48 grams per cubic centimeter, a through the plane resistivity of 200 to 1000 mOhm-cm, and an in plane resistivity of 15-65 mOhm-cm. The increased tensile and flexural properties also allow the non-woven textile fabric to be in the form of rolled goods, i.e., goods gathered in a roll which can be shipped, transported, handled and cut from the roll to form an electrochemical electrode substrate and especially to form a fuel cell electrode substrate.

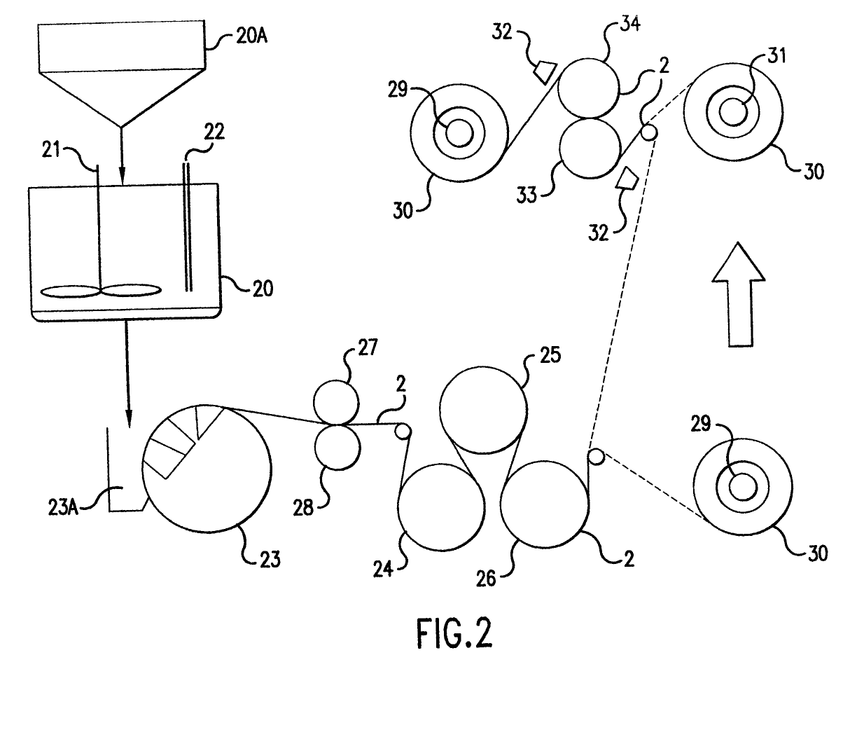

Turning now to FIG. 2, which is a diagrammatic illustration of the process of the invention, as briefly noted above, in order to prepare the present textile fabric, the staple fibers 3, the particulate filler 4, and a dispersion of a hydrophobic polymer 5, are dispersed in an aqueous medium to form a suspension thereof. In forming that suspension, usual paper making thickening agents, emulsifiers, and dispersants are used. It is, therefore, not necessary to detail those conventional ingredients, since these are well known in the art, although representative examples thereof are provided hereinafter. The suspension is then flocculated in a controlled manner to form flocs of a uniform combination of the carbon fibers, filler, and hydrophobic polymer. The flocs will also contain binder fibers, when used. Flocculation is carried out by conventional means of heat, mechanical agitation, and chemical additions, which are known to the papermaking art and need not be detailed herein. However, it is important that the flocculation of the suspension take place in a controlled manner. If the flocculation does not so take place, then it is difficult to uniformly deposit the suspension on a formaceous body and in a condition to form a uniform matrix.

The next step is, therefore, that of depositing the flocs on a formaceous body so as to form a matrix thereof. The formaceous body may be any of those conventionally used in the papermaking art, i.e., a screen belt or rotoformer, but preferably, a rotoformer is used for the reasons set forth below.

The matrix is then dewatered on the formaceous body to form a consolidated matrix. The matrix is then dried. Subsequently, the dried matrix is heated to temperatures sufficient to soften the hydrophobic polymer so as to fibrilate the hydrophobic polymer under mechanical pressure to form fibrils thereof, as explained above in connection with FIG. 1, and to, thus, form a strong, self-supporting textile fabric. When the binder fibers are used, the heating step burns off any remaining binder fibers and films of the binder fiber materials, i.e., removes the fugative binder so that it will not interfere with electrical conductivity in the finished non-woven textile fabric.

In order to make the suspension quite uniform, it is preferable that the suspension have between about 0.1% and 10% solids therein. This will allow good and complete flocculation by mechanical, chemical, or heat means, or combinations thereof, such that the flocs may be well placed on the formaceous body. Usually, the flocs are deposited on a screen from the head box of a conventional papermaking machine.

FIG. 2 illustrates the above in that the mixing chest 20, having a mixer 21, disperses the staple fibers 3, the particulate filler 4, and a dispersion of the hydrophobic polymer 5 in an aqueous medium to form a suspension thereof. By use of one or more high shear mixer 21, the addition of heat, e.g. in the form of hot water and/or steam through pipe 22, and chemical flocculating agents, e.g., a conventional ionic high molecular weight polymers, flocs are well-formed so that they may be uniformly deposited on the formaceous body shown in FIG. 2 as rotoformer 23. After the matrix is formed on rotoformer 23 and dewatered on rotoformer 23 by way of vacuum in the interior of the rotoformer, the matrix is passed through suitable rollers to a series of cans 24, 25 and 26. While not shown on the drawings, if desired, the matrix can be further dewatered before being received by the first can by conventional dewatering screens, so as to remove additional water and further consolidate the matrix 2.

The cans 24, 25 and 26 can be at the same or different temperatures. However, whatever the temperatures of the individual cans, and less or more than three may be used, the drying temperature which the matrix 2 experiences should be at least about 272° F. and up to about 350° F. and sufficient to substantially dry the matrix, e.g. to a moisture content of 10% or less. Thereafter the dried matrix is subjected to a heating step at temperatures sufficient to cause the hydrophobic polymer to be softened. It is this softening which causes the hydrophobic polymer, originally in the matrix in a dispersed form, to fibrilate among the carbon fibers, so as to disperse the hydrophobic polymer through the matrix. The fibrilation of the hydrophobic polymer renders the matrix substantially, or at least partially, hydrophobic and greatly increased the physical properties, especially tensile, of the finished non-woven textile fabric. When the hydrophobic polymer is poly(tetrafluoroethylene), the temperature of the heating step is preferably between about 600 and 700° F., and especially about 610-620° F. The heating step is usually carried our with heated rollers 33, 34 and IR heat sources 32. Finally, the completed textile fabric may be rolled onto a roller 29 to provide rolled goods 30 of the textile fabric 1.

A very important feature of the invention is that of providing such strength and properties to the textile fabric that it can be rolled into rolled goods. This allows a substantially continuous roll of the goods from which products, and especially fuel cell electrode substrates, can be quickly and economically cut. The fabric is also so strong that it can be handled in rolled form for shipment, placement and use. This is a very decided improvement over prior art textile fabrics of the present nature. Alternatively, the matrix 2 may be rolled onto roller 29 without passing through heated rollers 33, 34 (as shown by the dashed lines in FIG. 2) and subsequently unrolled from roll 31 and the passed through the heated rollers 33, 34. It is believed that it is the combination of the temperature, especially 610-620° F., and the pressure exerted on the hydrophobic polymer by heated rollers 33, 34 that causes the hydrophobic polymer to fibrilate into fine fibrils thereof. Generally speaking, the fibrilated hydrophobic ploymer will have fibrils of about 0.1 to 5 microns in average diameter, especially about 0.5 to 3 microns and averaage lengths of about 10 to 500 microns.

To achieve such pronounced fibrilation, mechanical pressure on matrix 2 between calandar rollers 33, 34 must be quite high, e.g., at least 100 pli and preferably between 150 and 400 pli (173 and 460 kg per linear cm).

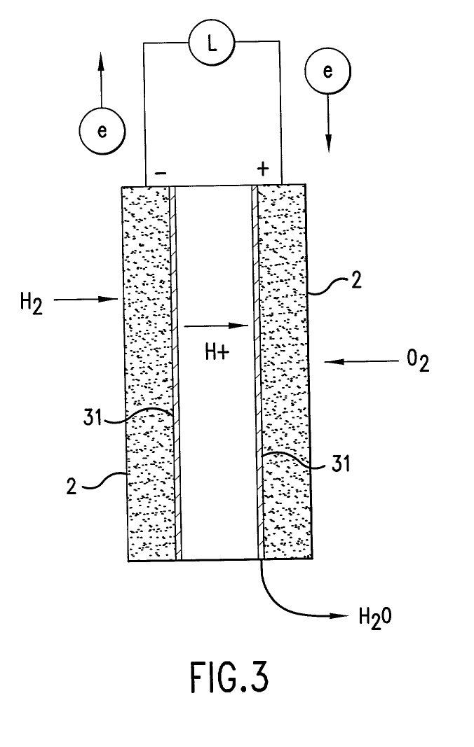

FIG. 3 diagrammatically illustrates a use of the present textile fabric 2. In a fuel cell, hydrogen molecules are presented to an electrode 31 which effect a catalytic decomposition and hydrogen ions so formed proceed through the electrolyte to another electrode 31 where they react with oxygen molecules, usually from air, to form water. The electrons from the first electrode pass through an external “load” and back to the other electrode to complete the circuit.

Thus, the process provides for the production of a flexible, controllable, continuous, low cost, commercial manufacture of electrical conducting textile fabrics for use in gas diffusion electrode substrates, as well as a host of other applications. The process is capable of being carried out with existing manufacturing equipment and techniques to form the present non-woven, conducting textile with excellent electrical, chemical and mechanical properties. The finished material may even be in the form of a continuous roll of the goods.

The wet laying process of the invention also maximizes the multi-directional uniform physical properties and electrical conductivity of the fabric and produces a highly active surface area with controlled porosity. In view of the greater strength of the non-woven textile, it may be made in smaller thicknesses and yet be handled, and will provide controlled hydrophobic/hydrophilic properties.

For some applications of fuel cell electrode substrates, it is desirable to have catalytic materials therein, e.g., catalytic platinum and platinum alloys. Since the present process is a wet laid process, this can easily be achieved.

Further, uniform flocculation of the present suspension can easily be achieved to produce correct flocs by the combination of thermal/mechanical/chemical flocculation as described above, and as is conventional in the papermaking art. These three means of flocculation, used in combination, can easily control the floc size and thus matrix formation for producing a uniform matrix and, ultimately, a uniform non-woven textile fabric. Specifically useful are conventional ionic polymeric substances which, when used with carefully controlled mechanical energy, can produce correct flocs.

An important feature of the process is that it can be carried out on conventional papermaking machines such as Fourdrinier machines and cylinders, as well as the preferred rotoformer. These machines also allow simultaneous depositions of more than one layer of the matrix, as is known in the art. Thus, in situations where the non-woven textile fabric should be layered, for particular applications, these conventional machines can be set-up in a known manner to produce layered matrixes.

Conventional papermaking machines also allow the additional of various known dispersions, emulsions, fine particle suspension and solutions to the matrix, either before or after being formed on the rotoformer to, in part, enhance a specific quality of the textile fabric for particular use, especially in filtration applications.

Indeed, if desired, other fibers, such as glass fibers and polymeric fibers may be used in the matrix in lieu of the carbon fibers where additional strengths are required on the matrix, especially for uses other than as fuel cell substrates.

Also, since the matrix is wet laid, it can be mechanically compressed between nip rollers 27, 28 (see FIG. 2) to consolidate the matrix, remove additional aqueous medium and control the caliper of the matrix.

The heating of the matrix to the temperatures and at the pressures noted above allows the hydrophobic polymer to fibrilate in the matrix and cause the matrix to be substantially hydrophobic. However, those temperatures also remove unwanted volatiles and smooth the fabric surface.

The textile fabric composition may vary widely, depending on the use intended, but for most applications the composition will have 10-100 parts of the staple fibers, 20-80 parts particulate fibers, and 1-30 parts hydrophobic polymer.

The invention will now be illustrated by the following examples where all percentages and parts are by weight, unless otherwise indicated, which is also the case for the foregoing specification and the following claims.

### EXAMPLE 1

The process of this example was carried out in an apparatus as schematically shown in FIG. 2 of the drawings. With water in hydrapulper 20A, carbon powder (Vulcan XC-72R carbon black from Cabot Corporation) is added to the hydrapulper. The hydrapulper is operated about 1 minute to form a consistency of about 1.7% solids by weight. The slurry is then transferred into the mixing chest 20 and diluted with water to a consistency of 0.95%. Mechanical agitation is used with mixer 21 and chopped staple PAN pyrolyzed carbon fibers (Px3CFO250-001 from Zoltek) are added to bring the consistency to approximately 1.04%. The staple pyrolyzed carbon fibers have an average length of about ¼″ (0.6 cm) with small amounts of lengths from ⅛″ to 1″ (0.32 to 2.54 cm). A 1% solution of fully hydrolyzed gum Karaya is added as a viscosity modifier and mild coagulant (the particular gum Karaya is Premium Powdered Gum Karaya No. 2HV from Importers Service Corp.). The gum stabilizes the dispersion of the carbon fibers and carbon. The gum is added in an amount so as to, by sight, form a stable dispersion.

The batch so constituted is rapidly heated by direct injection of steam through pipe 22 to a temperature of 125° F. (52° C.). An emulsion of poly(tetrafluoroethylene) polymer (PTFE type 30B from Dupont Corporation) is carefully added below the liquid surface in order to minimize the generation of foam. The amount is such that about 7% by weight of the matrix will be PTFE. Formation of foam is a result of surfactant and other emulsifying agents in the PTFE and has the deleterious effect of causing significant amounts of solids to float on the surface of the slurry, causing subsequent mass and composition variations and surface defects in the finished textile fabric. In addition, foam interferes with drainage on the rotoformer and can cause formation control problems that subsequently affect matrix properties. Use of anti-foaming and de-foaming agents are generally ineffective and tend to produce undesired side effects in polymer distribution within the textile fabric.

After the addition of the PTFE polymer dispersion, the rate of heat input is carefully controlled. If the heat addition is too rapid, localized hot spots occur, causing the fluoropolymer to irreversibly floc to itself and reduce its effectiveness. If the rate is too slow, production rate is reduced. It is also important to reduce the rate of mechanical energy input via the mixer to prevent destruction of flocs as they are forming. Relatively high sheer forces from the mechanical mixer can tear the flocs apart to a degree that, later, they will interfere with proper formation and solids retention. This requirement for minimal matrix must be balanced against the need to produce sufficient turbulence in the suspension so as to maintain a homogenous concentration of solids throughout the mixing chest. The degree of mechanical mixing can be assessed simply by observing the suspension in the head box. Thus, mechanical mixing is simply reduced to just about that point where the suspension in the mixing chest is no longer uniform.

Additional heating takes place until the temperature of the suspension in the head box reaches 170-180° F. (77-83° C.). At that point, the fluoropolymer emulsion becomes destabilized and allows the long chain molecules to flocculate the pyrolyzed carbon staple fibers and carbon powder in an intimate mixture. Cold dilution water is then added to lower the temperature to less than 130° F. (55° C.), and the consistency to approximately 0.3 to 0.8%. Agitation via the mixer is then increased to maintain the batch homogeneously. The suspension temperature is cooled to at least that temperature because, if not, the subsequent addition to staple, polyvinyl alcohol fibers, which are highly soluble at elevated temperatures, would dissolve too much for performing the purposes explained above. After cooling to below 130° F. (55° C.), the polyvinyl alcohol fibers are introduced into the head box (Kuralon VPB-105-2×4 mm polyvinylalcohol fibers from Kuraray Ltd.). The amount of polyvinyl alcohol fibers added is about 10% of that of the weight of the carbon staple fibers. Alternatively, the polyvinyl alcohol fibers may be dispersed in water in the hydropulper 20A and then added to the head box 23A. While, as noted above, the temperature of the dispersion of the head box must be less than 130° F. (55° C.), it is preferably below 90° F. (32° C.) so that thin films begin to form between fibers. The suspension in the mixing chest is then fed by conventional papermaking machinery to the forming machine, and usually via a conventional fan pump, which helps to size the flocs. An ionic surface charge fully hydrolyzed polymer solution of about 1% solids content is metered with a variable speed control displacement pump to the slurry after the fan pump and before the rotoformer. The polymer is Cartaretin AEM polyacrylamide from Clariant Chemical (that is a conventional flocculating material). This can be used to control floc formation along with the amount of the mechanical mixing taking place by the mixer and the fan pump. Floc size is important in controlling formation and solids retention, which is a major factor in determining final matrix properties in subsequent processing steps. Proper floc size and consistency can be determined by observing the flocs that are deposited on the rotoformer.

All of the usual features of a rotoformer are used to control matrix properties. Levels are run as high as possible, with maximum suction available applied to the various vacuum boxes to maximize drainage of the aqueous medium. The rate of drainage, in addition to impacting production rates, plays a role in the creation of composition gradients in the plane of the matrix. A conventional dandy roll may be applied and, in this example, is applied, to the matrix surface at or just below the point the matrix emerges from the slurry. The purpose is to increase suction, consolidate the sheet, and provide a smooth surface.

The wet matrix is compressed in felted nip press rolls 27, 28. The press rolls possess variable load and gap capability, and the gap is approximately ½ of the desired thickness and the load approximately 250 pounds per linear inch (288 kg per cm). The primary purpose of the nip rolls is to provide matrix consolidation and densification, and to improve mechanical and permeability characteristics, but water removal and improved caliper control are very beneficial side effects.

Initial drying is effected using a series of oil or steam filled cans 24, 25, 26, as is typical in the paper industry, heated about 270° F. (132° C.). The final matrix temperature is about 617° F. (325° C.) This final heating step is carried out on heated calendar rolls 33, 34 with about one third minute residence time and is then wound onto roll 29 to form roll goods 30. Alternatively, the dried matrix may be rolled into a roll and subsequently unrolled from roll 31 and heated to 617° F. (325° C.) with a separate calendar step, as shown by the dashed lines in FIG. 2. The purpose of the heating, e.g. on rolls 33, 34, is that of fibrilating the poly(tetrafluroethylene) polymer among the carbon fibers, caliper reduction, caliper variation reduction, and improved surface finish. If desired, but not necessary, additional matrix consolidation is also achieved which affects permeability and mechanical properties. A single nip, steel roll calendar with a variable pressure and gap capability may be used in that regard. The controlling factor and basis of adjustment is the finished caliper of the matrix. The equipment is operated in the same manner as the wet press described above but with loading in the vicinity of 500 pounds per linear inch (57.5 kg per cm).

If desired, although not performed in this example, the matrix may also have applied thereto various other compositions such as latex, polymers, coatings and the like, especially if used in applications other than as fuel cell electrode substrates. By following the foregoing process, textile fabrics of various properties can be produced by simple variations in the parameters of the above-described process, e.g., nip pressure, amount of ingredients and proportions thereof, and the like. The following Table 1 illustrates properties of the textile fabric, which can be achieved with such variations.

TABLE

| | | | TEST |
|---|---|---|---|
| PRO- | | | METHOD |
| PERTY | METRIC UNITS | ENGLISH UNITS | BASIS |
| Basis Weight | <50-150+ gm/m² | <30.7-92.2+ | TAPPI T- |
| | | lbs/3000 ft² | 410/ASTM |
| | | | D 646 |
| Caliper | <140-400+ μm | <5.5-15.6 mils | TAPPI T- |
| @ 5 KPa | 100 μm (min.) | 4.0 mils (min.) | 411 |
| @ 1.4 Mpa | | | TAPPI T- |
| | | | 411 |
| Compressive | 2.80 Mpa (min.) | 412 psi (min.) | Calculation |
| Modulus | | | from |
| | | | Calipers |
| Density | <0.300-.480+ gm/cm³ | <18.7-30+ lb/ft³ | Calculation |
| @ 5 KPa | | | from Basis |
| | | | Weight/ |
| | | | Caliper |
| Void | <75-85+% | Same | Calculation |
| Volume | | | from |
| @ 5 KPa | | | Components |
| | | | and Density |
| Mean Flow | <1.0 to 50+ μm | Same | ASTME |
| Pore | | | 128-94 |
| Q127 | <10-250+ mm H₂O | <0.4-12+ inch H₂O | ASTM-D |
| Resistance | | | 2986-91/ |
| | | | MIL-STD- |
| | | | 282 |
| Tensile | 1.75 N/cm (min.) | 454 gm/in (min.) | TAPPI |
| | | | T-494 |
| Young's | 25.5 Mpa (min.) | 3750 psi (min.) | Calculation |
| Modulus | | | from |
| | | | Tensile/ |
| | | | TAPPI |
| | | | T-456 |
| Resistivity | | | |
| Through | 200-1000+ mOhm-cm | Same | ASTM |
| Plane | | | B193-95 |
| In Plane | 15-65+ mOhm-cm | Same | ASTM |
| | | | B193-95 |
| Ash | <0.75% | Same | TAPPI |
| | | | T-413 |
| PTFE | 3.0-30+% | Same | Calculation |
| Content | | | from |
| | | | Material |
| | | | Balance |

While the Table 1 is believed to be self-explanatory, it is particularly noted that the tensile strength of the textile fabric is quite high while the resistivity in both through the plane and in the plane is quite favorable for good electrical conductivity. The textile fabrics also exhibit substantial hydrophobic properties.

The cell voltage versus the current density of the present fabric is essentially the same as that of those more expensive prior art fabrics. Thus, the present invention provides a very substantial advance in the art.

EXAMPLES 2 AND 3

| Ingredients | Example 2 | Example 3 |
|---|---|---|
| Pyrolyzed | | |
| Carbon Fiber (%) | 20.7 | 59.0 |
| Carbon Powder (%) | 71.2 | 36.0 |
| PTFE (%) | 6.3 | 3.2 |
| Karaya gum | 1.8 | 1.8 |
| Polyvinyl alcohol fibers | (See below) | |
| Matrix Properties | | |
| Basic Weight (gm/m²) | 119.2 | 126.4 |
| Caliper @ 5 KPa (micron) | 285 | 341 |
| Density @ 5 KPa (gm/m³) | 0.397 | 0.375 |
| Void Volume (%) | 78.1 | 84.4 |
| Caliper @ 1.4 Mpa (micron) | 218 | 218 |
| Compressive Modulus (MPa) | 5.00 | 3.88 |
| Mean Flow Pore Size (micron) | 5.0 | 10.2 |
| Pressure Drop @ 320 | 448 | 110 |
| cc/min/m² (mm H₂O) | | |
| Tensile (N/cm) | 4.0 | 5.1 |
| Youngs Modulus (MPa) | 79.2 | 85.3 |
| Resistivity (mOhm-cm) | | |
| In-plane | 56 | 33 |
| Thru-plane | 333 | 353 |

The commercial identifications of the ingredients are the same as in Example 1. The following procedure shows the particulars for Example 3 in parenthesis. Reference is made to FIG. 2.

The polyvinyl alcohol fibers were dispersed in cold water (<80° F./26° C., both Examples) using a 72 inch Black-Clawson vertical hydrapulper 20A at a consistency of 0.037%(0.042%) and diluted with cold water to a consistency of 0.015%(0.017%). The resulting slurry was transferred to a surge chest for continuous feed to the forming device 23.

The carbon powder was dispersed in warm water (150° F.-160° F./65° C.-72° C.) with the Black-Clawson Hydrapulper 20A at a consistency of 0.20%. This slurry was mixed with the pyrolyzed carbon fibers and PTFE emulsion to a consistency of 0.64%(0.75%) in the mixing chest 20 equipped with a variable speed dual level pitched blade radial flow agitator 21 and heated to 176° F. (<80° C.) with steam injected through pipe 22. This formed large flocs of carbon fibers/carbon particles/PTFE. Cold (<80° F./26° C.) water was added, cooling and diluting the batch to <120° F./49° C. and 0.31%(0.36%) consistency. Mechanical energy was added to the resultant slurry through the agitator at a controlled rate of 1.5-1.6 (1.85-1.95) watts/gal of slurry for a total energy input of 1.3-1.4 (1.8-1.9) watt-hr/gal of slurry for purposes of maintaining slurry homogeneity and reducing the floc size but preventing their breakdown.

The resultant slurry was transferred, in a semi continuous manner, to a surge chest equipped with a side entry axial flow propeller mixer. Mechanical energy was also added to the slurry via the agitator at the rate given above and for the same purpose so that total energy input is also equivalent.

The polyvinyl alcohol fibers slurry and floced carbon/PTFE slurry were continuously combined at the rate of 0.488(.521) gals of fibers slurry/gal of carbon/PTFE slurry as well as with cold water to form a slurry with a consistency of approximately 0.06%. The respective slurries were fed to a mixing point by variable speed centrifugal pumps through partially closed valves. The pumps operating speed and valve positions were chosen not only to control the volumetric rate of feed but also to produce a repeatable and desirable residence time in the centrifugal pumps allowing further reductions in floc size without breaking them down excessively. A previously prepared solution of 0.58% polyacrylamide polymer was continuously added to this combined slurry at an average rate of 2.22(8.10) mg/g of slurry solids. This was to rebuild flocs to the desired size and to ensure retention of the solids, in particular the carbon particles.

The final slurry was fed to a Sandy Hill rotoformer 23 with a variable speed pump and flow control valve as described above for the same purpose. The headbox of the rotoformer 23A was modified to accept a distributor roll and to allow submergence of a dandy roll into the pond of slurry such that at least part of the formation of the matrix takes place in the nip between the dandy roll and rotoformer drum. This ensured a good formation and a smooth surface. The distributor roll consisted of a series of fluted disks mounted on a variable speed rotating shaft. This ensured an even distribution of solid material across the forming area but did not disturb the flocs previously formed. The vacuum box position was adjusted to apply suction at this point in order to gain the drainage rate required to properly form the matrix. Additional suction was applied to the formed matrix to achieve a moisture content of 77-78% to ensure the efficacy of subsequent washing and pressing operations.

The formed matrix from the rotoformer 23, as described above, was washed with water at the rate of 750(675) ml/lb. Additional suction was applied in a controlled manner to reduce the moisture content back to 77-78%. The matrix was then run through a felted wet press of two hardened steel rolls 27 and 28 with a fixed gap of 0.160 inch (0.260 inch)/0.4 cm (0.66 cm) and capable of exerting force up to 225 phi (26.3 kg per cm). The pressed matrix was continually dried on steam filled cans 24, 25, 26 with a surface temperature of 270° F. (132° C.) and wound into a roll with controlled tension.

The wound roll was unrolled and exposed to hot rolls 33, 34 so that the matrix was heated at 618° F. for about one third minute and then calendared between 2 chilled steel rolls at a force of approximately 112(125) pli (130-146 kg per cm).

Cell performance (cell potential vs. current density) of fuel cells prepared from the matrix of Examples 2 and 3 is essentially the same as that of a conventionally prepared matrix, as described above.

It will be appreciated that the foregoing preferred embodiments are only illustrative of the present invention and that the invention extends to the spirit and scope of the annexed claims.

What is claimed is:

1. An at least partially hydrophobic, porous, electrical conducting, non-woven textile fabric, comprising:
(1) a flocculated and laid matrix of substantially uncoated electrical conducting staple fibers;
(2) electrical conducting particulate filler disposed in the matrix; and
(3) an at least partially hydrophobic polymer at least partially in the form of fibrils disposed in the matrix and at least partially attached to an mixed with the fibers and filler.

2. The textile fabric of claim 1, wherein the laid matrix is a wet laid matrix.

3. The textile fabric of claim 1, wherein the staple fibers have an average length between 1/16″ and ¾″.

4. The textile fabric of claim 3, wherein the staple fibers are metal fibers or electrical conducting polymer fibers or carbon fibers or mixtures thereof.

5. The textile fabric of claim 4, wherein the staple fibers have an average diameter of between 1 and 50 μm.

6. The textile fabric of claim 5, wherein the staple fibers are pyrolyzed carbon fibers.

7. The textile fabric of claim 6, wherein the pyrolyzed carbon fibers are derived from polyacrylonitrile.

8. The textile fabric of claim 7, wherein the pyrolyzed carbon fibers are pyrolyzed polyacrylonitrile fibers.

9. The textile fabric of claim 1, wherein the particulate filler is a metal or electrical conductive polymer or carbon.

10. The textile fabric of claim 9, wherein the particulate filler has an average particle diameter of between about 0.1 and 10.0 microns.

11. The textile fabric of claim 10, wherein the particulate filler is carbon.

12. The textile fabric of claim 11, wherein the carbon is in the form of carbon microfibers, milled carbon fibers, carbon black and acetylene carbon.

13. The textile fabric of claim 1, wherein the at least partially hydrophobic polymer is a fluorinated polymer.

14. The textile fabric of claim 13, wherein the fluorinated polymer is poly(tetrofluoroethylene).

15. The textile fabric of claim 1, wherein the weight amount of the hydrophobic polymer in the matrix is between 1% and 30% of the weight of the matrix.

16. The textile fabric of claim 15, wherein the amount is between 3% and 10%.

17. The textile fabric of claim 15, wherein the amount of staple fibers in the matrix is between about 10 and 100 parts by weight of the matrix.

18. The textile fabric of claim 17, where the amount of particulate filler in the matrix is between about 10 and 70 parts by weight of the matrix.

19. The textile fabric of claim 1 having a weight of 50-150 gms/m², a caliper of 140-400μm at 5Kpa, a density of 0.3 to 0.48 gms/cm³, a cross-plane resistivity of 200-1000 mOhm-cm, and in plane resistivity of 15-65 mOhm-cm.

20. The textile fabric of claim 1 in the form of rolled goods.

21. The textile fabric of claim 1 in the form of an electrochemical electrode substrate.

22. The textile fabric of claim 29 in the form of a fuel cell electrode substrate.

23. A process for producing the textile fabric of claim 1, comprising:
(1) dispersing the substantially uncoated staple fibers, the particulate filler and a suspension of the hydrophobic polymer in an aqueous medium to form a suspension thereof;
(2) flocculating the suspension to form flocs;
(3) depositing the flocs on a formaceous body to form a matrix thereof;
(4) dewatering the matrix on the formaceous body;
(5) heating the matrix at softening temperatures of the hydrophobic polymer;
(6) pressing the matrix at the softening temperatures to form fibrils of the hydrophobic polymer so that the fibrils are at least partially attached to and mixed with the carbon fibers and filler and form a strong, self-supporting textile fabric.

24. The process of claim 23, wherein the suspension has between about 0.1% and 10% solids therein.

25. The process of claim 23, wherein the flocculation is by heat, mechanical, or chemical means, or combinations thereof.

26. The process of claim 23, wherein the formaceous body is a screen of a papermaking machine and the flocs are deposited thereon.

27. The process of claim 26, wherein the matrix is dewatered by a vacuum next to the screen.

28. The process of claim 23, where the softening temperature is at least about 300° F. to 800° F., and sufficient to cause the hydrophobic polymer to be softened.

29. The process of claim 28, wherein the softening temperature is between about 600° F. and 700° F.

30. The process of claim 23, wherein the dewatered matrix is passed over cans for drying.

31. The process and claim 29, wherein the matrix is passed between nip rollers for fibrilating the hydrophobic polymer.

32. The process of claim 23, wherein the textile fabric is rolled onto a roller to provided roll goods.

33. A fuel cell having an electrode substrate made with the textile fabric of claim 1.
